(19) United States
(12) Patent Application Publication
(10) Pub. No.: US 2021/0154605 A1
(43) Pub. Date: May 27, 2021

(54) FILTER FOR WATER TREATMENT AND FILTER APPARATUS COMPRISING SAME

(71) Applicant: ARUN CO., LTD., Bupyeong-gu, Incheon (KR)

(72) Inventor: Soon-bong OH, Incheon (KR)

(73) Assignee: ARUN CO., LTD., Bupyeong-gu, Incheon (KR)

(21) Appl. No.: 17/047,578

(22) PCT Filed: Nov. 9, 2018
(86) PCT No.: PCT/KR2018/013643

§ 371 Date: Oct. 14, 2020

(30) Foreign Application Priority Data
Aug. 3, 2018 (KR) 10-2018-0090855

(51) Int. Cl. B01D 39/10; B01D 37/04; B01D 35/30; B01D 35/20; B01D 35/16

(52) U.S. Cl. CPC B01D 39/10; B01D 37/046; B01D 2201/18; B01D 35/20; B01D 35/16; B01D 35/30

(57) ABSTRACT

A filter for water treatment exhibiting high filtering capability by preventing vortices, and a filter apparatus including same is provided. The filter for water treatment, which is a cross flow type filter, includes a metal thin plate and a plurality of micropores passing through the metal thin plate so as to filter water flowing on one side of the metal thin plate. A micropore includes an inlet port which is formed on one surface of the metal thin plate and through which water flows in; a discharge port which is formed on the other surface positioned opposite from the one surface of the metal thin plate, and through which the water flowing in through the inlet port is discharged; and a curved portion convexly curved towards the inside of the micropore connects the inlet port and the discharge port. The curved portion and the other surface form a singular surface.

### TECHNICAL FIELD

The present invention relates to a water treatment filter and a filter apparatus comprising same, and more particularly, relates to a water treatment filter exhibiting high filtering capability by preventing vortices and a filter apparatus comprising same.

### BACKGROUND ART OF THE INVENTION

The filter is made of a plate or tubular material with a porous plate material, and is interposed in the tubular portion through which the fluid flows to perform the function of filtering foreign substances contained in the flowing fluid.

When such a filter performs a filtration process to remove foreign substances from the supplied water, micropores formed in the filter are clogged by foreign substances.

A filter to prevent a phenomenon that such micropores are blocked by foreign substances, that is, filter clogging phenomenon, is disclosed in Korean Patent Publication No. 10-2006-0037051. The disclosed filter comprises a cylindrical support frame having an opening in a side surface thereof and a plurality of thin plates covering the side surface of the support frame and being overlapped with each other, wherein a plurality of micropores are formed in the thin plate, the micropores have a minimum diameter at a central position in the thickness direction, and a groove connecting the micropores is formed on a surface opposite to the surface facing the support frame side of the thin plate to improve the filtering efficiency. In the disclosed filter, foreign substances trapped in the micropores is removed by pulsed air ejected toward the direction of filtering.

However, in such a filter, the micropores formed in the filter are opened parallel to the direction of fluid transfer, and the diameter of the inner wall of the groove forming the micropores is enlarged, reduced, and enlarged in the shape of an hourglass so that the foreign substances are often attached to the inner wall of the groove, and thus, there is a problem in that micropores must be frequently backwashed by a pulsed air in a state where the filtering process is stopped.

Moreover, foreign substances sticking to the inner wall of the groove located at the upstream end in the filtering direction have a problem that they are not separated from the inner wall of the groove by backwashing.

Korean Patent Registration No. 1763916 is disclosed for solving such problems. The disclosed filter assembly is made of a filter assembly wherein a filter equipped with a plurality of taper-shaped micropores whose diameter is getting narrower as it travels toward the horizontal or downstream end of the flow direction of the fluid containing solid foreign substances, is distributedly equipped at the upstream end of the branch pipe branched to form a filtering flow path being passed through the filter in cooperation with the distribution duct and a non-filtering flow path not being passed through the filter, in the middle of the distribution duct through which the fluid containing the foreign substance flows.

In the filter assembly with this configuration, contaminated water containing foreign substances is divided into filtered fluid and non-filtered fluid by the filter, and foreign substances stuck in the opening contacts the exposed surface of the upstream side more than the exposed surface of the downstream side. Therefore, as the foreign substances flow faster on the exposed surface of the upstream side than on the exposed surface of the downstream side, a lift force is generated against the foreign substances according to the Bernoulli principle, and the foreign substances stuck in the opening can be separated from the opening by the lift force. Accordingly, even if the filtration treatment for contaminated water is performed for a long time, the opening formed in the filter is not blocked, thereby providing an effect of continuously performing the filtration process without filter replacement or filter cleaning.

However, when a fluid containing a high concentration of solid foreign substances is filtered, there has been a problem in that air bubbles contained in the high concentration fluid adhere to the inner and outer surfaces of the filter and the inner surfaces of the plurality of openings formed in the filter, and generate a surface tension which causes the solid foreign substances contained in the fluid to adhere to the filter, thereby reducing the filtration efficiency.

In addition, the filter comprises a thin plate and an opening penetrating through the thin plate, and the angle between the inner side of the opening and one side of the thin plate rapidly changes at a point where the opening ends. Accordingly, the fluid discharged from the filter forms vortices at the point where the opening ends. There has been a problem in that the vortices reduce the amount of filtration by acting as a resistance against the fluid passing through the opening.

In addition, a filter is provided inside the distribution duct to filter contaminated water. In this case, a laminar (streamline) flow is formed between the outer surface of the filter and the inner circumferential surface of the distribution duct. This laminar (streamline) flow also plays a function of removing foreign substances (cake) laminated on a cross flow type filter. When the laminar (streamline) flow has different flow rates along the outer circumferential surface of the filter, vortices occur in some sections of the laminar (streamline) flow. There has been a problem in that the generated vortices act as resistance against the laminar (streamline) flow and eventually reduce the flow velocity of the entire laminar (streamline) flow, thereby degrading the function of removing foreign substances (cake) in the laminar (streamline) flow.

### SUMMARY OF INVENTION

### Technical Problems

An objective of the present invention is to provide a filter for water treatment and a filter apparatus comprising same that remove the foreign substances adhered to a filter during a filtration process, through an embodiment.

Another objective of the present invention is to provide a filter for water treatment and a filter apparatus comprising same that increase the amount of filtration by reducing the formation of vortices in a fluid passing through the filter, through an embodiment.

Another objective of the present invention is to provide a filter for water treatment and a filter apparatus comprising same that minimize the decrease in the flow velocity of laminar (streamline) flow by reducing the formation of vortices in the laminar (streamline) flow between the filter and the distribution duct in which the filter is accommodated, through an embodiment.

Another objective of the present invention is to provide a filter for water treatment and a filter apparatus comprising same that detect clogging of the filter and remove the clogging of the filter at an appropriate time, through an embodiment.

### Technical Solution

According to an aspect of the present invention, there is provided a filter for water treatment which is a cross flow type filter for water treatment, comprising: a metal thin plate; and a plurality of micropores passing through the metal thin plate so as to filter water flowing on one side of the metal thin plate, wherein a micropore includes: an inlet port being formed on one surface of the metal thin plate, wherein water flows in the micropore through the inlet port; a discharge port being formed on the other surface positioned opposite from the one surface of the metal thin plate, wherein the water flowing in through the inlet port is discharged through the discharge port; and a curved portion, being convexly curved towards an inside of the micropore, connecting the inlet port and the discharge port, wherein the curved portion and the other surface form a singular surface. According to another aspect of the present invention, the curved portion and the one surface of the metal thin plate may form the singular surface.

According to another aspect of the present invention, the filter may further comprise a discharge adjacent portion, provided on the other surface of the metal thin plate, located between the two closest micropores, and the discharge adjacent portion may be formed convex in a direction away from the metal thin plate.

According to another aspect of the present invention, the discharge adjacent portion may be formed on the singular surface.

According to another aspect of the present invention, the micropore may be formed with a minimum diameter in one region of the curved portion, wherein the ratio between the diameter of the inlet port, the minimum diameter, and the diameter of the discharge port may be 2:1:2.

According to another aspect of the present invention, the micropore may be formed with a minimum diameter in one region of the curved portion, wherein the ratio between the diameter of the inlet port, the minimum diameter, and the diameter of the discharge port may be 5:1:5.

According to another aspect of the present invention, the micropore may be formed with a minimum diameter in one region of the curved portion, wherein the ratio of the minimum diameter to the thickness of the metal thin plate may be 50% or more.

According to another aspect of the present invention, there is provided a filter apparatus comprising: a distribution duct where contaminated water containing foreign substances flows; a filter assembly provided inside the distribution duct and comprising a filter housing formed by being extended in the lengthwise direction of the distribution duct, and a cross flow type filter for water treatment provided on an outer circumferential surface of the filter housing and filtering a part of the contaminated water and guiding it into the filter housing; and spacers provided at a regular interval along the outer circumference of the filter assembly so that a distance between the outer circumferential surface of the housing and the inner circumferential surface of the distribution duct is kept constant along the outer circumference of the housing. According to another aspect of the present invention, the spacers may be extended in the lengthwise direction of the filter assembly.

According to another aspect of the present invention, the spacer may be formed in a streamlined shape.

According to another aspect of the present invention, the center of mass of the filter for water treatment may be disposed toward the upstream side spaced apart from the center of mass of the filter housing.

According to another aspect of the present invention, there is provided a control method for a filter apparatus comprising: a distribution duct where contaminated water containing foreign substances flows; a filter assembly provided inside the distribution duct and comprising a filter housing formed by being extended in the lengthwise direction of the distribution duct, and a cross flow type filter for water treatment provided on an outer circumferential surface of the filter housing and filtering a part of the contaminated water and guiding it into the filter housing; an ultrasonic generator adjacent to the filter assembly and generating ultrasonic waves; and a pressure sensor that is provided toward the downstream side spaced apart from the filter assembly and senses a water pressure of the distribution duct, wherein the control method comprises the steps of: supplying pre-filtered clean water into the filter housing; supplying contaminated water containing foreign substances into the distribution duct after stopping supplying of pre-filtered clean water; determining whether the filter is clogged based on the pressure detected by the pressure sensor; and cleaning the filter by performing at least one of generating ultrasonic waves in the ultrasonic generator and supplying pre-filtered water to the filter housing when it is determined that the filter is clogged in the step of determining whether the filter is clogged.

According to another aspect of the present invention, in the step of supplying the clean water, the clean water may be supplied into the filter housing without passing through the filter so that foreign substances of the filter are discharged to the distribution duct.

According to another aspect of the present invention, in the step of supplying the clean water, when the clean water is supplied, the ultrasonic generator may generate ultrasonic waves toward the filter for water treatment.

According to another aspect of the present invention, the step of cleaning the filter may comprise a first filter cleaning mode in which ultrasonic waves are generated by the ultrasonic generator; and a second filter cleaning mode in which ultrasonic waves are generated by the ultrasonic generator and pre-filtered water is supplied into the filter housing. According to another aspect of the present invention, the first filter cleaning mode may be executed when the pressure detected by the pressure sensor is within a predetermined range, and the second filter cleaning mode may be executed when the pressure detected by the pressure sensor exceeds the predetermined range.

### Advantageous Effects of Invention

According to at least one of embodiments of the present invention, a filter for water treatment and a filter apparatus comprising same can have the following effects.

According to at least one of embodiments of the present invention, the filter and the filter apparatus can have an effect of removing foreign substances adhered to the filter during the filtration process.

According to at least one of embodiments of the present invention, the filter and the filter apparatus can have an effect of increasing the amount of filtration by reducing the formation of vortices in the fluid passing through the filter. According to at least one of embodiments of the present invention, the formation of vortices in a laminar (streamline) flow between a filter and a distribution duct in which the filter is accommodated is reduced, thereby the filter and the filter apparatus can have an effect of minimizing the decrease in the flow velocity of the laminar (streamline) flow. According to at least one of embodiments of the present invention, the filter and the filter apparatus can have an effect of removing the clogging of the filter at an appropriate time by detecting clogging of the filter.

### BRIEF DESCRIPTION OF DRAWINGS

FIG. 1 is a schematic diagram for explaining a filter for water treatment and a filter apparatus comprising same according to an embodiment of the present invention according to an embodiment of the present invention.

FIG. 2 is an exploded perspective view showing the filter assembly illustrated in FIG. 1.

FIG. 3 is a diagram for explaining vortices generally appearing in a fluid that has been passed through the filter.

FIG. 4 is a cross-sectional view showing the filter illustrated in FIG. 1.

FIG. 5 is a cross-sectional view showing the filter shown in FIG. 1 and a first filter support portion supporting the filter.

FIG. 6 is an exploded perspective view showing a spacer that separates the filter assembly shown in FIG. 1 from a distribution duct.

FIG. 7 is a cross-sectional view showing the filter assembly separated from the inner side surface of the distribution duct through the distribution duct and the spacer.

FIG. 8 is a schematic diagram showing a distribution duct and a filter assembly.

FIG. 9 is a flowchart showing a method of controlling a filter apparatus according to an embodiment of the present invention.

FIG. 10 is a flowchart specifically explaining the control method shown in FIG. 9.

### DETAILED DESCRIPTION OF EMBODIMENTS

It should be understood that the embodiments described hereinafter are illustratively shown to aid understanding of the invention, and the present invention may be implemented with various modifications different from the embodiments described herein. However, in describing the present invention, when it is determined that a detailed description of a well-known function or component may unnecessarily obscure the gist of the present invention, the detailed description and detailed illustration thereof will be omitted. In addition, the accompanying drawings are not drawn to scale to aid understanding of the invention, but dimensions of some components may be exaggeratedly illustrated.

The terms ‘first’ and ‘second’ used in the present application may be used to describe various components, but the components should not be limited by the terms. The terms are only used for the purpose of distinguishing one component from another component.

In addition, terms used in the present application are only used to describe specific embodiments, and are not intended to limit the scope of the rights. Singular expressions include plural expressions unless the context clearly indicates otherwise. In the present application, terms such as “comprise”, “consist of” or “comprised of” are intended to designate the existence of features, numbers, steps, operations, elements, components, or combinations thereof described in the present application, and it is to be understood that it does not preclude the possibility of the presence or addition of one or more other features or numbers, steps, operations, elements, components, or combinations thereof.

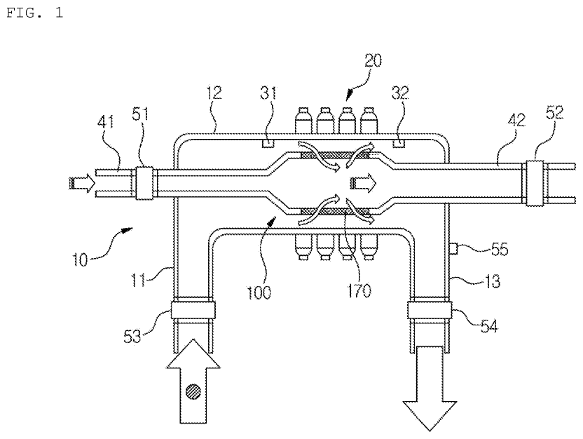

Hereinafter, a filter for water treatment 170 and a filter apparatus 1 comprising same according to an embodiment of the present invention will be described with reference to FIGS. 1 and 2. FIG. 1 is a schematic diagram for explaining a filter for water treatment 170 and a filter apparatus 1 comprising same according to an embodiment of the present invention, and FIG. 2 is an exploded perspective view showing the filter assembly 100 illustrated in FIG. 1.

Referring to FIGS. 1 and 2, a filter for water treatment 170 and a filter apparatus 1 comprising same according to an embodiment of the present invention comprises a distribution duct 10 through which contaminated water containing foreign substances flows, a filter assembly 100 provided inside the distribution duct 10 and comprising a cross flow type filter for water treatment 170, and a spacer 70 that separates the filter assembly 100 from the distribution duct 10.

The distribution duct 10 is formed so that contaminated water containing foreign substances flows inside, and it comprises a supply duct 11 to supply contaminated water, a connection duct 12 communicating with the supply duct 11 and forming a predetermined angle with the supply duct 11, and a discharge duct 13 communicating with the connection duct 12 and forming a predetermined angle with the connection duct 12. The contaminated water passes through the supply duct 11, the connection duct 12, and the discharge duct 13 in sequence. The contaminated water flowing through the discharge duct 13 may be fed back into the supply duct 11 or discharged to another apparatus.

The filter assembly 100 is accommodated in the connection duct 12 and performs a function of filtering the supplied contaminated water. The filter assembly 100 comprises a filter housing formed by being extended in the lengthwise direction of the connection duct 12, and a cross flow type filter for water treatment 170 (hereinafter referred to as a filter) being provided on the outer circumferential surface of the filter housing 110, filtering a part of contaminated water, and guiding it into the filter housing 110.

The filter housing 110 comprises a first housing 111 positioned upstream side of the connection duct 12 and a second housing 113 positioned downstream side of the first housing 111. The contaminated water flowing inside the connection duct 12 passes through the first housing 111 and the second housing 113 in sequence. The filter housing 110 is supply with clean water through a first filtration duct 41 and discharges the filtered water through a second filtration duct 42. The first filtration duct 41 supplies clean water from the outside of the distribution duct 10 to the filter housing 110, and the second filtering duct 42 discharges the filtered water inside the filter housing 110 to the outside of the distribution duct 10.

Such filter housing 110, as illustrated in FIG. 7, comprises a first housing 111 communicating with the first filtration duct 41, and a second housing 113 communicating with the second filtration duct 42. The first housing 111 and the second housing 113 are spaced apart from each other, and a filter 170 is provided between the first housing 111 and the second housing 113.

The first housing 111 comprises a first protruding duct 111a communicating with the first filtration duct 41, and a first inclined portion 111b communicating with the first protruding duct 111a and gradually increasing in diameter toward the downstream side, and a first body portion 111c whose outer circumferential surface is formed approximately horizontally with the direction in which the contaminated water flows.

The second housing 113 comprises a second protruding duct 113a communicating with the second filtration duct 42, a second inclined portion 113b communicating with the second protruding duct 113a and gradually increasing in diameter toward the downstream side, and a second body portion 113c whose outer circumferential surface is formed approximately horizontally with the direction in which the contaminated water flows. The first body portion 111c and the second body portion 113c are formed so as to be coupled to the both ends of the filter 170, respectively.

The filter 170 is a cross flow type filter for water treatment 170, and comprises a plurality of micropores 173 penetrating the metal sheet to filter a part of the water flowing from one side of the metal thin plate and the metal sheet. The filter 170 may be coupled to the filter housing 110 by rolling so that both ends located opposite to each other meet. In this case, an internal space is formed inside by the filter 170 and the filter housing 110, and the contaminated water filtered by the filter 170 is collected in the internal space of the filter housing 110, and discharged through the second filtration duct 42. A detailed description of the filter 170 will be described later.

Meanwhile, the filter housing 110 may further comprise a first support part 150 and a second support part 130 for supporting the filter 170.

The first support portion 150 is in contact with and supports the filter 170, and, as an example, may be formed in a honeycomb structure in which a through hole 151 of the first support portion 150 is formed. Like the filter 170, it is rolled so that both ends located opposite to each other meet, and then coupled to the filter housing 110.

The second support part 130 contacts and supports the first support part 150, and, as for an example, it may be formed in a grid-like structure. It is formed in the shape of a hollow cylinder, and both ends thereof are coupled to the filter housing 110.

Accordingly, the contaminated water passes through the filter 170, the first support part 150, and the second support part 130 in sequence.

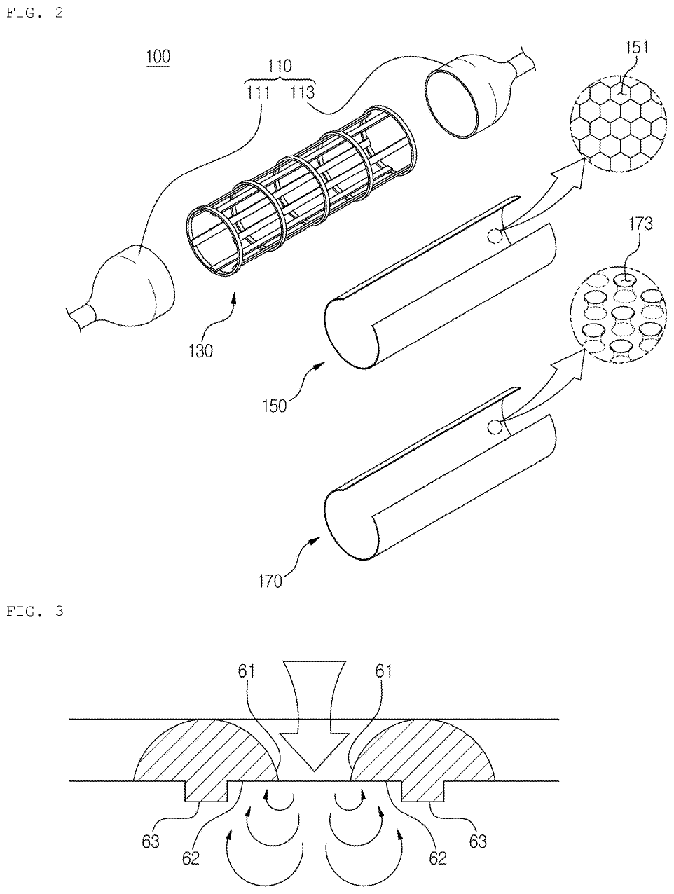

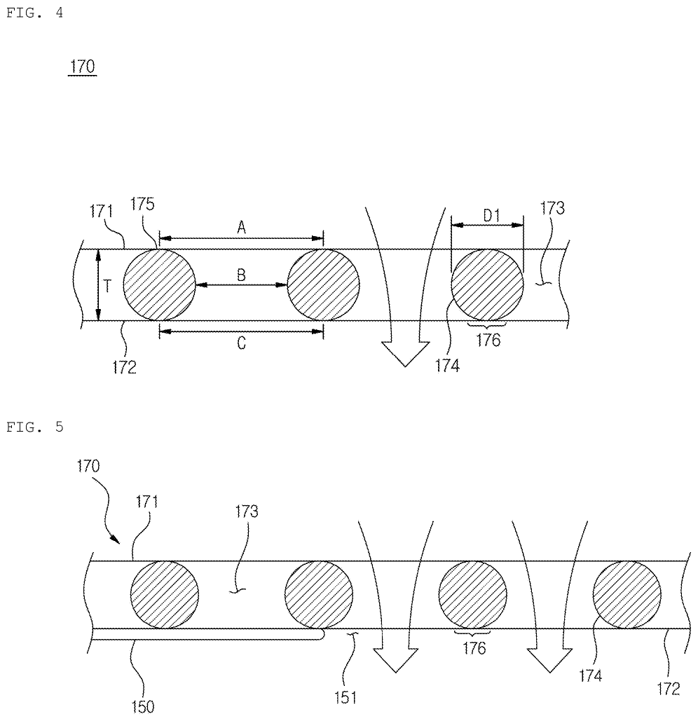

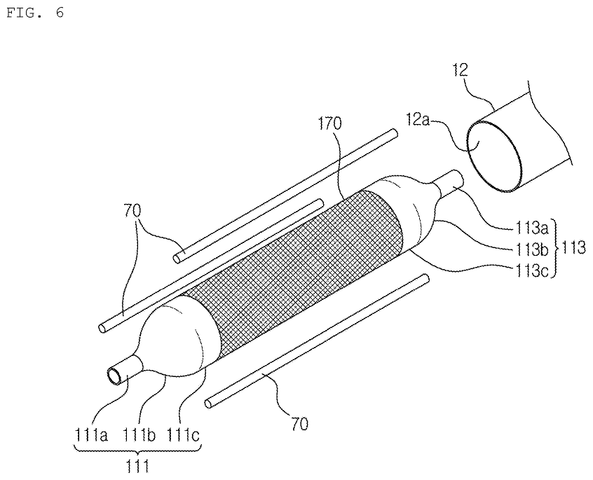

Hereinafter, the filter 170 will be described in detail with reference to FIGS. 3 to 6. FIG. 3 is a view for explaining vortices generally appearing in the fluid passing through the filter 170, FIG. 4 is a cross-sectional view showing the filter 170 illustrated in FIG. 1, and FIG. 5 is a cross-sectional view showing the filter 170 illustrated in FIG. 1 and the first support part 150 supporting the filter 170.

A general filter 170 is made of a thin plate in which micropores 173 are formed as illustrated in FIG. 3, and the inner side surface 61 of the micropores 173 and one surface 62 of the thin plate form a predetermined angle. Accordingly, vortices are formed in the fluid passing through the micropores 173 along the arrow. These vortices hinder the flow by acting as a resistance against the flowing fluid. In addition, support protrusions 63 for supporting the thin plate may be formed, and vortices may be additionally formed by the support protrusions 63. Therefore, the filtering amount per unit time of the filter 170 is not high.

Referring to FIG. 4, the micropores 173 of the filter 170 according to an embodiment of the present invention may comprise an inlet port A formed on one surface 171 of the thin metal plate and into which water flows, a discharge port C formed on the other surface 172 located on the opposite side of the metal sheet and through which the water introduced through the inlet port A is discharged, and a curved portion 174 that is convexly curved toward the inner side of the micropores 173 to connect the inlet A and the discharge port C. as the curved portion 174 and the other surface 172 of the thin metal plate may form a singular surface.

The filter 170 may let the contaminated water supplied to the micropores 173 through the inlet port A be discharged into the filter housing 110 through the discharge port C after filtering through curved portion 174. In this case, the filter 170 can minimize the occurrence of vortices in the fluid leaving the micropores 173 because the curved portion 174 forms a curved surface, and the curved portion 174 and the other surface 172 of the thin metal plate form the singular surface. Accordingly, the amount of filtration can increase. Meanwhile, the inlet port A is illustrated to have a circular cross-section crossing the lengthwise direction of the micropores 173 in FIG. 2, but is not limited thereto, and may be formed in various shapes such as a rectangle and the like, and A discharge adjacent portion 176 located between the two closest micropores 173 may be formed on the other surface 172 of the thin metal plate. The discharge adjacent portion 176 may be convexly formed in a direction away from the metal thin plate. In other words, a portion between the two micropores 173 formed in the thin metal plate may be formed in a streamlined shape. Accordingly, generation of vortices in the fluid leaving the micropores 173 can be further minimized. The discharge adjacent portion 176 and the curved portion 174 may form the singular surface.

The filter 170 may be formed such that the curved portion 174 and the one surface 171 of the thin metal plate form the singular surface. In this case, the occurrence of vortices in laminar (streamline) flow, which will be described later, may be reduced.

Meanwhile, the micropores 173 have a minimum diameter B in one region of the curved portion 174. When the foreign substances contained in the contaminated water are larger than the minimum diameter B, since they cannot pass through the micropores 173, the minimum diameter B may be defined as the diameter of the micropores 173.

The micropores 173 may have a ratio of 2:1:2 between the diameter of the inlet A, the minimum diameter B, and the diameter of the discharge port C, for an example.

Approximately, the diameter of the inlet port A may be 40 μm, the minimum diameter B may be 20 μm, and the diameter of the discharge port C may be 40 μm.

Of course, it does not exclude the case where: the diameter of the inlet port A is 40 μm, the minimum diameter B is 14 μm, the diameter of the discharge port C is 40 μm; the diameter of the inlet port A is 40 μm, the minimum diameter B is 8 μm, the diameter of the discharge port C is 40 μm; the diameter of the inlet port A is 40 μm, the minimum diameter B is 4 μm, the diameter of the discharge port C is 40 μm; or, the diameter of the inlet port A is 40 μm, the minimum diameter B is 1 μm, the diameter of the discharge port C is 40 μm. Accordingly, the ratio between the diameter of the inlet port A, the minimum diameter B, and the diameter of the discharge port C may be 5:1:5.

However, when the ratio between the diameter of the inlet port A, the minimum diameter B, and the diameter of the discharge port C is 2:1:2, the foreign substances trapped in the micropores 173 can be easily escaped by the laminar (streamline) flow. In this case, the higher the ratio of the minimum diameter B, the easier it is for foreign substances to be escaped.

Meanwhile, the filter 170 may have 50% or more of the ratio of the minimum diameter B to the thickness T of the thin metal plate. When the thickness T of the thin metal plate is too large than the minimum diameter B, foreign substances cannot easily be escaped due to the laminar (streamline) flow. For an example, the thickness T of the metal thin plate may be 20 μm and the minimum diameter B may be 20 μm. Of course, the case where the thickness T of the metal thin plate is 23 μm and the minimum diameter B is 14 μm, 8 μm, 4 μm, and 1 μm is not excluded.

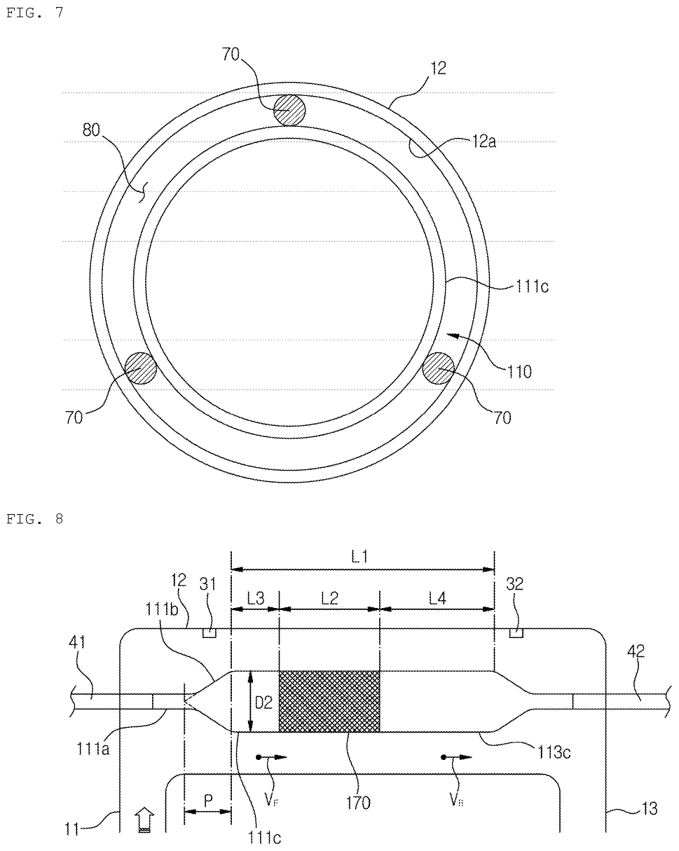

Meanwhile, referring to FIG. 6, the first support part 150 (referring to FIG. 2) is in contact with the other surface of the filter 170 to support the filter 170 in which the micropores 173 (referring to FIG. 2) may be formed. The contaminated water that has passed through the micropores 173 (referring to FIG. 2) may be in contact with the first support part 150 (referring to FIG. 2) while passing through the through hole 151 (referring to FIG. 2) formed in the first support part 150 (referring to FIG. 2). In this case, the filtered contaminated water may have vortices formed by the first support part 150 (referring to FIG. 2).

Since the filtered contaminated water passes through the through hole 151 (referring to FIG. 2) formed in the first support part 150 (referring to FIG. 2), the formation of vortices can be reduced when the part forming the circumference of the through hole 151 (referring to FIG. 2) is formed in a round shape without being angled through electrolytic polishing.

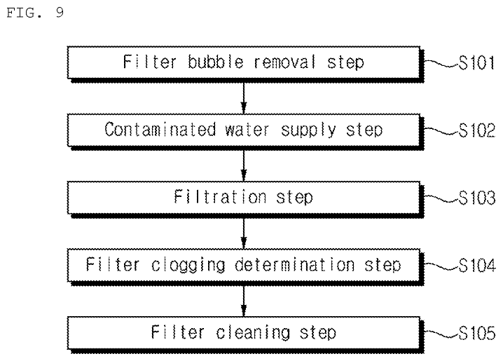

Hereinafter, a characteristic of maintaining a laminar (streamline) flow formed between the filter assembly 100 and the distribution duct 10 will be described with reference to FIGS. 6 to 8.

Referring to FIGS. 6 to 8, a laminar (streamline) flow forming space 80 may be provided between the outer circumferential surface of the filter assembly 100 and the inner circumferential surface of the distribution duct 10. When the thickness of the laminar (streamline) flow forming space 80, that is, the distance between the outer circumferential surface of the filter assembly 100 and the inner circumferential surface of the distribution duct 10 is formed equally along the outer circumference of the filter assembly 100, it is helpful in maintaining the laminar (streamline) flow.

In other words, on the cross-section crossing the lengthwise direction of the filter assembly 100, the distance between the outer circumferential surface of the filter assembly 100 and the inner circumferential surface of the distribution duct 10 is formed equally along the outer circumference of the filter assembly 100, is helpful in maintaining the laminar (streamline) flow.

In the case, when the distance between the outer circumferential surface of the filter assembly 100 and the inner circumferential surface of the distribution duct 10 is not formed equally along the outer circumference of the filter assembly 100, a difference in flow velocity occurs between the laminar (streamline) flows. This difference in flow rate does not maintain laminar (streamline) flow and generates vortices in some sections. Since vortices act as a resistance against laminar (streamline) flow, the flow rate of the laminar (streamline) flow decreases and the function of removing foreign substances trapped in the filter 170 is degraded.

On the outer circumferential surface of the filter assembly 100, as illustrated in FIGS. 6 and 7, a bar-shaped spacer 70 being extended in the lengthwise direction of the filter assembly 100 may be provided in parallel to the filter assembly 100. Two or more spacers 70 may be disposed at intervals along the circumference of the filter assembly 100. Therefore, the thickness of the spacers 70 and the thickness of the laminar (streamline) flow forming space 80 may be substantially identical. Accordingly, as the bar-shaped spacers 70 are used, the laminar (streamline) flow can be maintained with a simple configuration, thereby reducing cost and improving durability.

The spacer 70 may be formed in a shape whose diameter gradually decreases as both ends travel farther away from the center. For example, the spacer 70 may have a central portion parallel to the flow of contaminated water, but the overall shape may be streamlined. Accordingly, the spacer 70 can reduce the occurrence of vortices by minimizing interference of laminar (streamline) flow.

Meanwhile, the laminar (streamline) flow formed in the contaminated water flows along the outer circumferential surface of the filter assembly 100, while a portion thereof is filtered by the filter 170 and the other portion thereof is not filtered and discharged through a discharge duct 13. When filtration of contaminated water starts, a portion of the supplied contaminated water is filtered and introduced into the inner circumference of the filter assembly 100.

Accordingly, the rear end velocity formed on the downstream side of the filter assembly 100 is smaller than the front end velocity formed on the upstream side of the filter assembly 100. The rear end speed becomes smaller as it travels toward the downstream side. Accordingly, the removal rate of foreign substances forming a cake on the filter 170 by the foreign substances becomes lowered as it travels toward the rear end of the filter 170.

Accordingly, the filter 170 may be disposed, for an example, such that the center of mass is spaced apart from the center of mass of the filter housing 110 toward the upstream side. In other words, the separation distance L3 between the front end of the filter 170 and the front end of the filter housing 110 may be smaller than the separation distance L4 between the rear end of the filter 170 and the rear end of the filter housing 110. In this case, the length L2 of the filter 170 and the length L1 of the filter housing 110 may be set in consideration of the amount of filtration.

Meanwhile, the filter housing 110 has a larger diameter of the portion where the filter 170 is mounted, and the diameter thereof is getting smaller as it travels away from the portion where the filter 170 is mounted. This is to increase the amount of filtration. In particular, when the filter housing 110 is formed so that the outer circumferential surface of the portion on which the filter 170 is mounted is parallel to the flow of contaminated water, as illustrated in FIG. 6, a first inclined portion 111b and a second inclined portion 113b may have a sharp slope at the front or rear end. In this case, vortices may be formed in the contaminated water by the first slope 111b and the second slope 113b in a portion of the laminar (streamline) flow.

In this case, in order to minimize the occurrence of vortices, the length between the point where the lines being extended in the lengthwise direction of the filter housing 110 along the outer circumferential surface of the first inclined portion 111b provided at the top and bottom of the filter housing 110 meet and the point where the first inclined portion 111b ends may be formed to be larger than the diameter of the filter housing 110.

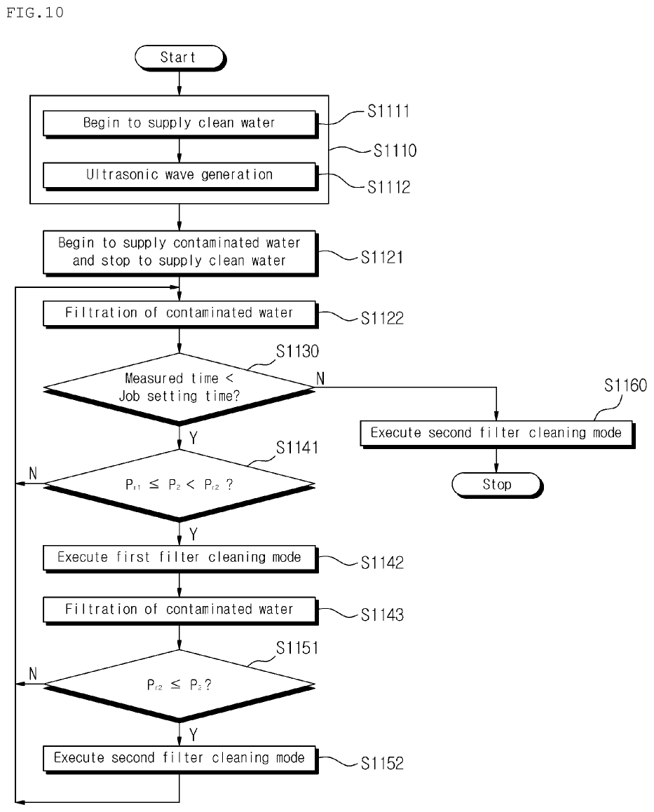

Meanwhile, a control method of the filter apparatus 1 according to an embodiment of the present invention for smooth filtration of contaminated water will be described with reference to FIGS. 9 and 10.

In this case, a filter apparatus 1 comprises: a distribution duct 10 through which contaminated water containing foreign substances flows; a filter housing 110 provided inside the distribution duct 10 and being extended in the lengthwise direction of the distribution duct 10; a filter assembly 100 comprising a cross flow type filter for water treatment 170 being provided on the outer circumferential surface of the filter housing 110, filtering a part of contaminated water, and guiding it inside the filter housing 110; an ultrasonic generator 20 adjacent to the filter assembly 100 and generating ultrasonic waves; a pressure sensor 32 that is provided spaced apart toward the downstream side from the filter assembly 100 and detects the water pressure of the distribution duct 10; and a control unit 55 that controls the cleaning of the filter 170 through a signal received from the pressure sensor 32.

In the control unit 55, an input unit (not shown) that receives a control command from a user and a display unit (not shown) that displays the input control command may be formed therein. The control unit 55 controls the opening and closing valve and the ultrasonic generator 20 through a signal received from the pressure sensor 32.

The filter apparatus 1 may further comprise a pressure sensor 31 that is provided spaced apart from the filter assembly 100 toward the upstream side and detects the water pressure of the distribution duct 10, wherein the pressure sensor 31 spaced apart toward the upstream side is referred to as a first pressure sensor 31, and the pressure sensor 32 spaced apart toward the downstream side is referred to as a second pressure sensor 32.

Referring to FIG. 9, the control method comprises: a filter bubble removal step S101, a contaminated water supply step S102, a filtration step S103, a filter clogging determination step S104, and a filter cleaning step S105.

The filter bubble removal step S101 is a step of removing bubbles that may be formed when a fluid is supplied. This is to prevent air bubbles that may occur when contaminated water is first supplied to the filter 170 exposed to air, and is a step of preventing the formation of air bubbles rather than removing already formed air bubbles.

The contaminated water supply step S102 is a step of opening a third opening and closing valve 53 and the fourth opening and closing valve 54 to allow contaminated water to flow inside the distribution duct 10.

The filtration step S103 is a step in which contaminated water flowing inside the distribution duct 10 passes through the filter 170.

The filter clogging determination step S104 is a step in which the control unit 55 determines whether the filter 170 is clogged by using the water pressure detected by the first pressure sensor 31 and the second pressure sensor 32.

The filter cleaning step S105 is a step in which when the control unit 55 determines whether the filter is clogged or not, a first opening and closing valve 51 and a second opening and closing valve 52 are opened, or at the same time, the ultrasonic generator 20 controls the ultrasonic generator 20 to generate ultrasonic waves.

The control method will be described in more detail with reference to FIG. 11.

The filter bubble removal step S1110 comprises a purified water supply step S1111 of supplying pre-filtered clean water into the filter housing 110 by opening the opening and closing valve of the first filtration duct 41, and an ultrasonic generation step S1112 of generating ultrasonic waves toward the filter 170 by the ultrasonic generator 20 when supplying clean water. In FIG. 11, it is shown that they are executed sequentially, but they may be executed simultaneously, and only one of them may be executed if necessary. These explanations do not exclude generating ultrasonic waves toward the filter 170 by the ultrasonic generator 20 in the purified water supply step S1111.

The purified water supply step S1111 is also a step in which clean water is supplied inside the filter housing 110 without passing through the filter 170 so that foreign substances previously accumulated in the filter 170 are discharged to the distribution duct 10.

After that, the third opening and closing valve 53 and the fourth opening and closing valve 54 are opened so that contaminated water flows inside the distribution duct 10, and the first opening and closing valve is closed, thereby executing a clean water supply stopping step S1121. After that, a contaminated water filtering step S1122 is executed. Thereafter, the control unit 55 measures the filtration elapsed time, and determines whether the measurement time elapses from the job setting time inputted through the input unit (S1130).

If it is determined that the measurement time has elapsed the job setting time (S1130-Y), the control unit 55 controls to end after executing a second cleaning mode (S1160), which will be described later.

If the control unit 55 determines that the measurement time has not elapsed from the job setting time (S1130-N), the control unit 55 starts cleaning the filter 170 according to the pressure of the second pressure sensor 32.

When the filter 170 is clogged, the water pressure at which the second pressure sensor 32 is located increases. This is because the amount of contaminated water passing through the filter 170 is reduced due to the clogging of the filter 170. When the pressure value detected by the second pressure sensor 32 rises and falls within a specific range, for example, when the pressure value detected by the second pressure sensor 32 is greater than or equal to the first reference value Pr1 and the second reference value is less than Pr2 (S1141-Y), the first filter cleaning mode is executed (S1142).

The first filter cleaning mode is a step in which ultrasonic waves are generated by the ultrasonic generator 20.

If the pressure value detected by the second pressure sensor 32 is not within a specific range, that is, when the pressure value detected by the second pressure sensor 32 is less than the first reference value Pr2 (S1141-N), the first filter cleaning mode will not be executed.

When the cleaning of the filter 170 is finished by the first filter cleaning mode, filtration of contaminated water is continuously executed (S1143).

After that, if the pressure value detected by the second pressure sensor 32 is within a specific range (S1151-Y), that is, the pressure value detected by the second pressure sensor 32 exceeds the second reference value Pr2. In one case, the second filter cleaning mode is executed.

The second filter cleaning mode is a step in which the ultrasonic generator 20 generates ultrasonic waves and supplies pre-filtered water into the filter housing 110. The high pressure means that the filter 170 is clogged severely. If the pressure value detected by the second pressure sensor 32 does not exceed the second reference value (S1151-N), the second filter cleaning mode will not be executed.

As described above, although the present invention has been explained by limited embodiments and drawings, the present invention is not limited thereto, and the technical idea of the present invention, and it goes without saying that various modifications and variations are possible within the equivalent scope of the claims to be described below by those of ordinary skill in the art to which the present invention pertains.

DESCRIPTION OF SYMBOLS

| | |
|---|---|
| 1: filter apparatus according to an | |
| embodiment of the present invention | |
| 10: distribution duct | 11: supply duct |
| 12: connection duct | 13: discharge duct |
| 70: spacer | 100: filter assembly |
| 110: filter housing | 130: second support part |
| 150: first support part | 170: filter |
| 173: micropore | |

1. A filter for water treatment, which is a cross flow type filter for water treatment, comprising:
a metal thin plate; and
a plurality of micropores passing through the metal thin plate so as to filter water flowing on one side of the metal thin plate,
wherein a micropore includes:
an inlet port being formed on one surface of the metal thin plate, wherein water flows in the micropore through the inlet port;
a discharge port being formed on the other surface positioned opposite from the one surface of the metal thin plate, wherein the water flowing in through the inlet port is discharged through the discharge port; and
a curved portion, being convexly curved towards an inside of the micropore, connecting the inlet port and the discharge port, wherein the curved portion and the other surface form a singular surface.

2. The filter for water treatment according to claim 1, wherein the curved portion and the one surface of the metal thin plate form the singular surface.

3. The filter for water treatment according to claim 1, further comprising a discharge adjacent portion, provided on the other surface of the metal thin plate, located between the two closest micropores,
wherein the discharge adjacent portion is formed convex in a direction away from the metal thin plate.

4. The filter for water treatment according to claim 3, wherein the discharge adjacent portion is formed on the singular surface.

5. The filter for water treatment according to claim 1, wherein the micropore is formed with a minimum diameter in one region of the curved portion, and
wherein the ratio between the diameter of the inlet port, the minimum diameter, and the diameter of the discharge port is 2:1:2.

6. The filter for water treatment according to claim 1, wherein the micropore has a minimum diameter in one region of the curved portion, and
wherein the ratio between the diameter of the inlet port, the minimum diameter, and the diameter of the discharge port is 5:1:5.

7. The filter for water treatment according to claim 1, wherein the micropore is formed with a minimum diameter in one region of the curved portion, and
wherein the ratio of the minimum diameter to the thickness of the metal thin plate is 50% or more.

8. A filter apparatus comprising:
a distribution duct where contaminated water containing foreign substances flows;
a filter assembly provided inside the distribution duct and comprising a filter housing formed by being extended in the longitudinal direction of the distribution duct, and a cross flow type filter for water treatment provided on an outer circumferential surface of the filter housing and filtering a part of the contaminated water and guiding it into the filter housing; and
spacers provided at a regular interval along the outer circumference of the filter assembly so that a distance between the outer circumferential surface of the housing and the inner circumferential surface of the distribution duct is kept constant along the outer circumference of the housing.

9. The filter apparatus according to claim 8, wherein the spacers are extended in the lengthwise direction of the filter assembly.

10. The filter apparatus according to claim 9, wherein the spacers are formed in a streamlined shape.

11. The filter apparatus according to claim 8, wherein the center of mass of the filter for water treatment is disposed toward the upstream side spaced apart from the center of mass of the filter housing.

12. A control method for a filter apparatus comprising:
a distribution duct where contaminated water containing foreign substances flows;
a filter assembly provided inside the distribution duct and comprising a filter housing formed by being extended in the lengthwise direction of the distribution duct, and a cross flow type filter for water treatment provided on an outer circumferential surface of the filter housing and filtering a part of the contaminated water and guiding it into the filter housing;
an ultrasonic generator adjacent to the filter assembly and generating ultrasonic waves; and
a pressure sensor that is provided toward the downstream side spaced apart from the filter assembly and senses a water pressure of the distribution duct,
wherein the control method comprises the steps of:
supplying pre-filtered clean water into the filter housing;
supplying contaminated water containing foreign substances into the distribution duct after stopping supplying of pre-filtered clean water; determining whether the filter is clogged based on the pressure detected by the pressure sensor; and
cleaning the filter by performing at least one of generating ultrasonic waves in the ultrasonic generator, and supplying pre-filtered water to the filter housing, when it is determined that the filter is clogged in the step of determining whether the filter is clogged.

13. The control method for a filter apparatus according to claim 12, wherein in the step of supplying the clean water, the clean water is supplied into the filter housing without passing through the filter so that foreign substances of the filter are discharged to the distribution duct.

14. The control method for a filter apparatus according to claim 12, wherein in the step of supplying the clean water, when the clean water is supplied, the ultrasonic generator generates ultrasonic waves toward the filter for water treatment.

15. The control method for a filter apparatus according to claim 12, wherein in the step of supplying the clean water, wherein the step of cleaning the filter comprises: a first filter cleaning mode in which ultrasonic waves are generated by the ultrasonic generator; and a second filter cleaning mode in which ultrasonic waves are generated by the ultrasonic generator and pre-filtered water is supplied into the filter housing.

16. The control method for a filter apparatus according to claim 15, wherein in the first filter cleaning mode is executed when the pressure detected by the pressure sensor is within a predetermined range, and the second filter cleaning mode is executed when the pressure detected by the pressure sensor exceeds the predetermined range.
